(19) United States
(12) Patent Application Publication
(10) Pub. No.: US 2024/0280980 A1
(43) Pub. Date: Aug. 22, 2024

(54) AUTOMATED MACHINE MONITORING

(71) Applicant: KEYPROD, Paris (FR)

(72) Inventors: Damien Jacky MARC, Blandy (FR); Jean-Luc Gilbert Henri DION, Montevrain (FR); Martin Pierre Michel GHIENNE, Nanterre (FR); Arkadiusz KOSECKI, Viarmes (FR)

(21) Appl. No.: 18/567,673

(22) PCT Filed: Mar. 31, 2022
(86) PCT No.: PCT/EP2022/058588

§ 371 Date: Dec. 6, 2023

(30) Foreign Application Priority Data
Jun. 7, 2021 (FR) FR2105996

(51) Int. Cl. G05B 23/02

(52) U.S. Cl. CPC G05B 23/0267

(57) ABSTRACT

Automated methods and systems for machine monitoring are disclosed. Some embodiments, given by way of example, may include the processing of data associated with a machine by carrying out a time-frequency decomposition, by carrying out phase grouping, by carrying out cross-correlated time-frequency pseudo-distribution, and/or by carrying out peak detection on shared power in order to detect machine cycles. Some embodiments, given by way of example, may carry out a learning operation followed by a process-monitoring operation, thereby facilitating adjustment and operation with limited user interaction.

### TECHNICAL FIELD

The present invention relates generally to systems and methods for monitoring equipment and manufacturing processes, and more particularly, to automated data analysis and reporting systems and methods for machines in a production environment.

### BACKGROUND

Systems for monitoring manufacturing machines are commonly used in a variety of applications where it is desired to obtain items of information with respect to the operation of the machines, in particular numerical-control machines, in a production environment, such as a factory. Conventional monitoring systems often require access to the machine's control software and modification thereof, as well as connectivity between the machine's control system and the monitoring system. Such access and such modification can be difficult or costly, and certain machines may not easily be connected to a monitoring system. Consequently, it is desired to provide an automated machine monitoring system which avoids or limits the need for a direct interface with control software or a control system of a machine.

### DISCLOSURE OF THE INVENTION

The present invention provides improved systems and methods for automated machine monitoring. In an embodiment, the automated machine monitoring system comprises:
a first sensor arranged to detect a first parameter associated with a first machine;
a first processor functionally coupled to receive data associated with the first parameter originating from the first sensor, the first processor being able to process the data associated with the first parameter by at least one of the following actions consisting of carrying out a time-frequency decomposition, carrying out a phase clustering, carrying out a cross-correlated time-frequency pseudo-distribution, and carrying out a peak detection on a common energy to detect first machine cycles; and
an interface device able to display at least the data or items of information from among the processed data and the items of information relating to the data.

According to the invention, the first processor can be placed in a first machine module associated with the first machine; and the first machine module can be functionally connected to the interface device by means of a network.

According to the invention, the first sensor can be functionally connected to a first machine module associated with the first machine; and the first processor can be placed in a computing device, the computing device being functionally connected to the first machine module and to the interface device by means of a network.

According to the invention, the first sensor can be functionally connected to a first machine module associated with the first machine; and the first processor can be placed in the interface device, the interface device being functionally connected to the first machine module by means of a network.

According to the invention, the first sensor can be placed in position from among on the first machine, in the first machine, and in a first machine module associated with the first machine.

According to the invention, the system can comprise moreover a second sensor arranged to detect a second parameter associated with the first machine, the second sensor being functionally connected to the first processor.

According to the invention, the first sensor can be able to detect at least one from among a vibration, a sound, a pressure, a movement, an acceleration, a temperature, a magnetic field, an electromagnetic field, and a light.

According to the invention, the system can comprise moreover:
a second sensor arranged to detect a second parameter associated with a second machine, and
a second processor functionally coupled to receive data associated with the second parameter originating from the second sensor, the second processor being able to process the data associated with the second parameter by at least one of the following actions consisting of carrying out a time-frequency decomposition, carrying out a phase clustering, carrying out a cross-correlated time-frequency pseudo-distribution, and carrying out a peak detection on a common energy to detect second machine cycles.

The invention comprises moreover a data analysis method, the method comprising the operations consisting of:
carrying out a time-frequency decomposition of a time signal associated with the operation of a machine in order to produce a complex matrix with a time-frequency decomposition;
carrying out a phase clustering on the complex matrix with a time-frequency decomposition in order to produce a real label sequence vector;
carrying out a cross-correlated time-frequency pseudo-distribution on the real label sequence vector in order to produce a real matrix with a time-frequency decomposition; and
carrying out a peak detection on a common energy on the real matrix with a time-frequency decomposition in order to produce a real common energy vector.

According to the invention, the method can comprise moreover, before the operation consisting of carrying out a time-frequency decomposition, the operation consisting of obtaining the time signal associated with the operation of the machine by collecting data via a sensor placed at least in one of the positions from among in and on the machine.

According to the invention, the operation consisting of carrying out a time-frequency decomposition can comprise the operations consisting of applying a Hann window function and carrying out a short-time Fourier transform.

According to the invention, the operation consisting of carrying out a phase clustering can comprise the operation consisting of carrying out adaptive k-means clustering.

According to the invention, the operation consisting of carrying out a cross-correlated time-frequency pseudo-distribution can comprise the operation consisting of applying a cross-correlation with an increasing window width and an increasing time offset.

According to the invention, the operation consisting of carrying out a peak detection on a common energy can comprise the operation consisting of calculating a common energy by summing the windows for each time offset and detecting the peaks thereof which are at least one from among isolated and narrow.

The invention can comprise moreover a machine monitoring method that comprises a learning step as a function of any one from among the method defined above, and a process monitoring step.

The process monitoring operation can comprise the operations consisting of:
carrying out a time-frequency decomposition of a time signal associated with the operation of a machine in order to produce a complex matrix with a time-frequency decomposition;
carrying out a phase clustering on the complex matrix with a time-frequency decomposition in order to produce a real label sequence vector;
carrying out a cross-correlated time-frequency pseudo-distribution on the real label sequence vector in order to produce a real matrix with a time-frequency decomposition;
carrying out a peak detection on a common energy on the real matrix with a time-frequency decomposition in order to produce a real common energy vector; and
outputting items of information relating to the operation of the machine.

According to the invention, the items of information relating to the operation of the machine can comprise at least items of information from among the production of a part by the machine, a total number of parts produced by the machine, a total cycle count of the machine, a log of the parts produced by the machine, a log of the machine cycles, a rate of production of parts by the machine, an efficiency of production, a cycle time required for the production of a part, a deviation with respect to a predicted parameter, and a usage rate of the machine.

The invention can comprise moreover an automated machine monitoring system such as defined above in the present application.

Although the invention will be described with respect to certain embodiments, it will be understood that the invention is not limited to these embodiments. On the contrary, the invention comprises all of the variants, modifications and equivalents such as can be comprised within the context of the present disclosure.

The objects and advantages above and others of the present invention will become apparent from the attached drawings and the description thereof.

### BRIEF DESCRIPTION OF THE DRAWINGS

The attached drawings, which are incorporated into this description and which constitute a part thereof, illustrate embodiments given by way of example of the invention, and, with a general description of the example given above, and the detailed description given below, serve to explain the principles of the invention.

Other advantages and features of the invention will become apparent on examination of the detailed description of an embodiment, non-limitatively, and of the attached drawings, in which:

FIG. 1 illustrates a first embodiment given by way of example of an automated machine monitoring system as a function of the principles of the present invention.

FIG. 2 illustrates a second embodiment given by way of example of an automated machine monitoring method as a function of the principles of the present invention.

FIG. 3 illustrates a second embodiment given by way of example of an automated machine monitoring method as a function of the principles of the present invention.

### DETAILED DESCRIPTION

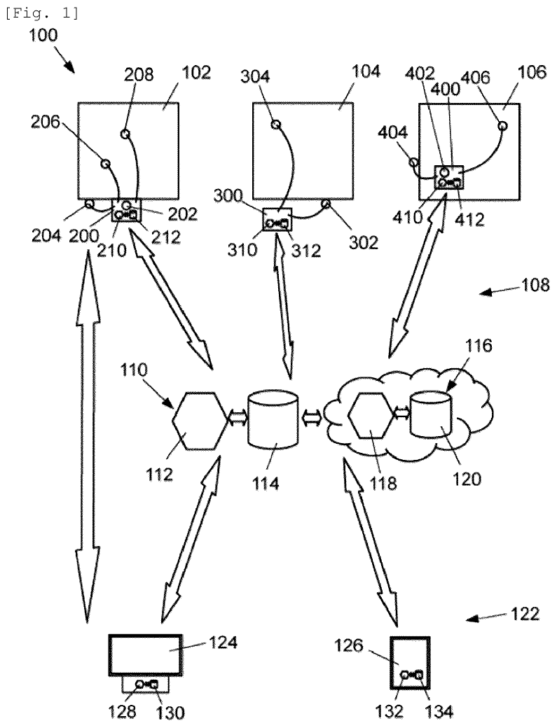

FIG. 1 is a schematic diagram representing an automated machine monitoring system 100 given by way of example, as a function of at least certain aspects of the present disclosure. The system 100 can be used with one or more production machines 102, 104, 106. The machines 102, 104, 106 can comprise, non-limitatively, milling machines, lathes, grinding machines, cutting machines (laser, water jets, ceramic and metallic cutting tools), welding machines, punching machines, additive manufacturing machines, and/or drilling machines which may be used, for example, in a manufacturing or production process.

With reference to the machine 102, the system 100 can comprise a machine module 200 which can be placed on the machine 102. For example, the machine module 200 can be fastened on an external part of the machine 102, such as by means of fastening parts (for example, bolts) and/or adhesive. For example, the machine module can be placed on an enclosure or a housing of the machine 102. In certain embodiments given by way of example, the machine module 200 can comprise a processor 210 configured to carry out at least some of the different operations described in the present application. In certain embodiments given by way of example, the machine module 200 can comprise a data storage device 212, which can be functionally coupled to the processor 210. The data storage device 212 (and other data storage devices described in the present application) can be used to store data and/or items of information associated with the operation of the machines 102, 104, 106 and/or to store computer-readable instructions which can be executed by the processor 210 (and other processors described in the present application) in order to carry out different operations such as described in the present application.

The system 100 can comprise one or more sensors 202, 204, 206, 208 which can be configured to detect parameters associated with the operation of the machine 102. Each of the sensors 202, 204, 206, 208 can be functionally coupled (for example, by means of wires or wirelessly) to provide data relating to such parameters to the machine module 200.

In certain embodiments given by way of example, one or more sensors 202 associated with the machine 102 can be placed on the machine module 200. In certain embodiments given by way of example, one or more sensors 204 associated with the machine 102 can be placed on an external part of the machine 102 remote from the machine module 200. For example, the sensor 204 can be placed on an enclosure or a housing of the machine 102. In certain embodiments given by way of example, one or more sensors 206, 208 can be placed internally inside the machine 102. For example, the sensors 206, 208 can be placed on a device for supporting a workpiece, a toolholder head, and/or a support structure.

With reference to the machine 104, the system 100 can comprise a machine module 300 which can be associated with the machine 104. For example, the machine module 300 can be placed close to the machine 104, but without being attached thereto. In certain embodiments given by way of example, the machine module 300 can comprise a processor 310 configured to carry out at least some of the different operations described in the present application. In certain embodiments given by way of example, the machine module 300 can comprise a data storage device 312, which can be functionally coupled to the processor 310.

The system 100 can comprise one or more sensors 302, 304 which can be configured to detect parameters associated with the operation of the machine 104. Each of the sensors 302, 304 can be functionally coupled (for example, by means of wires or wirelessly) to provide data relating to such parameters to the machine module 300.

In certain embodiments given by way of example, one or more sensors 302 associated with the machine 104 can be placed on an external part of the machine 104 remote from the machine module 200. For example, the sensor 302 can be placed on an enclosure or a housing of the machine 104. In certain embodiments given by way of example, one or more sensors 304 can be placed internally inside the machine 104. For example, the sensor 304 can be placed on a device for supporting a workpiece, a toolholder head, and/or a support structure.

With reference to the machine 106, the system 100 can comprise a machine module 400 which can be placed internally inside the machine 106. For example, the machine module 400 can be placed on a device for supporting a workpiece, a toolholder head, and/or a support structure in the machine 106. In certain embodiments given by way of example, the machine module 400 can comprise a processor 410 configured to carry out at least some of the different operations described in the present application. In certain embodiments given by way of example, the machine module 400 can comprise a data storage device 412, which can be functionally coupled to the processor 410.

The system 100 can comprise one or more sensors 402, 404, 406 which can be configured to detect parameters associated with the operation of the machine 106. Each of the sensors 402, 404, 406 can be functionally coupled (for example, by means of wires or wirelessly) to provide data relating to such parameters to the machine module 400.

In certain embodiments given by way of example, one or more sensors 402 associated with the machine 106 can be placed on the machine module 400.

In certain embodiments given by way of example, one or more sensors 404 associated with the machine 106 can be placed on an external part of the machine 106 remote from the machine module 400. For example, the sensor 404 can be placed on an enclosure or a housing of the machine 106. In certain embodiments given by way of example, one or more sensors 406 can be arranged internally inside the machine 106. For example, the sensor 406 can be placed on a device for supporting a workpiece, a toolholder head, and/or a support structure.

In certain embodiments given by way of example, the machine modules 200, 300, 400 can be functionally coupled to a network 108 to facilitate communication with other devices, such as one or more computing devices 110, which can comprise a processor 112 and/or a data storage device 114. In certain embodiments given by way of example, the network 108 can comprise a private network providing connectivity between the machine modules 200, 300, 400 and the computing device 110, such as on a manufacturing site. In certain embodiments given by way of example, the network 108 can comprise the public internet and the computing device 110 can be located at a distance with respect to the manufacturing site. Generally, the network 108 can use any suitable wired and/or wireless communication technologies.

In certain embodiments given by way of example, the machine modules 200, 300, 400 can be configured to communicate with one or more cloud-based computing devices 116, which can comprise a processor 118 and/or a data storage device 120. For example, the machine modules 200, 300, 400 can communicate directly with the cloud-based computing device 116, over the network 108, which can comprise the public internet. In a variant or in addition, the machine modules 200, 300, 400 can communicate with the cloud-based computing device 116 by means of the computing device 110, which can communicate with the cloud-based computing device 116, such as by means of the public internet.

The system 100 can comprise one or more interface devices 122, such as one or more personal computers 124 (for example, a desktop computer or a laptop computer) and/or one or more mobile devices 126 (for example, a smartphone or an electronic tablet). In certain embodiments given by way of example, the interface devices 122 can be used by staff who can benefit from access to items of real-time information (or in near-real time) and/or items of historical information relating to the operation of the machines 102, 104, 106. For example, a business owner and/or a factory manager can use the interface devices 122 to obtain items of information relating to the operation of the machines 102, 104, 106 on demand and/or to receive automated alerts relating to the operation of the machines 102, 104, 106.

In certain embodiments given by way of example, the interface devices 122 can be configured to receive data relating to the operation of one or more from among the machines 102, 104, 106 by means of the computing device 110 and/or by means of the cloud-based computing device 116. In a variant or in addition, certain systems 100 can be configured to manage communication between the machine modules 200, 300, 400 and the interface device 122, such as by means of a private network and/or the public internet. The personal computer 124 can comprise a processor 128 configured to carry out at least some of the different operations described in the present application. The personal computer 124 can comprise a data storage device 130, which can be functionally coupled to the processor 128. The mobile device 126 can comprise a processor 132 configured to carry out at least some of the different operations described in the present application. The mobile device 126 can comprise a data storage device 134, which can be functionally coupled to the processor 132.

In certain embodiments given by way of example, the data relating to the machines 102, 104, 106 obtained by one or more sensors 202, 204, 206, 208, 302, 304, 402, 404, 406 (for example, accelerometers) can be analyzed and the relevant items of information relating to the operations of the machines 102, 104, 106 can be provided by means of the interface devices 122. For example, the data can be analyzed to identify and count the machine cycles and to provide automated alerts relating to the machine cycles.

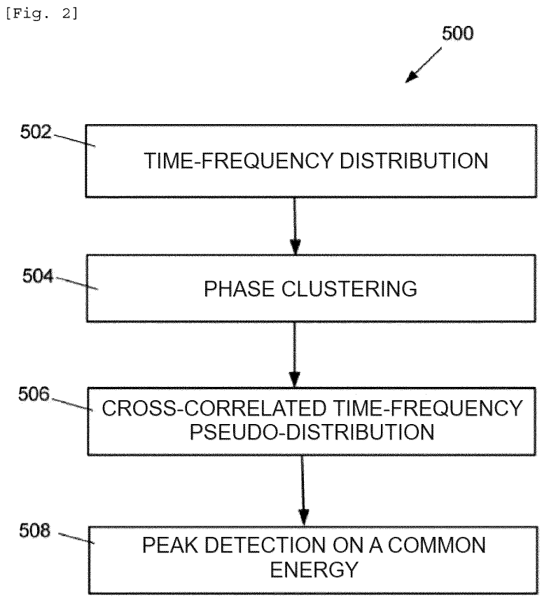

FIG. 2 is a flow chart of a data analysis method 500 given by way of example, to for example identify and count the machine cycles, as a function of at least certain aspects of the present disclosure. The operation 502 can comprise the operation consisting of carrying out a time-frequency decomposition. The operation 504 can follow the operation 502. The operation 504 can comprise the operation consisting of carrying out a phase clustering. The operation 506 can follow the operation 504. The operation 506 can comprise a cross-correlated time-frequency pseudo-distribution. The operation 508 can follow the operation 506. The operation 508 can comprise a peak detection on a common energy.

In certain embodiments given by way of example, the operation 502 can be preceded by one or more other operations, such as the operations consisting of collecting data intended to be analyzed, storing the data intended to be analyzed (for example, in one or more data storage devices 212, 312, 412, 114, 120, 130, 134), retrieving the data intended to be analyzed (for example, originating from one or more data storage devices 212, 312, 412, 114, 120, 130, 134), transmitting the data intended to be analyzed, and/or receiving the data intended to be analyzed.

In certain embodiments given by way of example, the operation 502, a time-frequency decomposition, can comprise the operation consisting of carrying out a short-time Fourier transform on the data (time signals). In certain embodiments given by way of example, this can comprise the operation consisting of applying a Hann window function on the time signal before the application of the discrete Fourier transform. In certain embodiments given by way of example, the output of the operation 502 can comprise a complex matrix with a time-frequency decomposition.

In certain embodiments given by way of example, a sampling rate can be approximately 10 kHz and there can be approximately 1024 samples in each block with a duration of approximately 0.1 second. On each of the 1024 samples, the Hann window can be applied on the time signal before the application of the discrete Fourier transform.

In certain embodiments given by way of example, the operation 504, a phase clustering, can comprise the operation consisting of carrying out an adaptive k-means clustering for a dimensionality reduction on the complex matrix with a time-frequency decomposition resulting from the operation 502. In certain embodiments given by way of example, the output of the operation 504 can comprise a real label sequence vector.

In certain embodiments given by way of example, the clustering operation can reduce the dimensionality from 1024 to 1. The number of groups can be chosen taking into account the inertia convergence between groups. The centroids of the initial group can be established at random, and the final set of centroids of the group can be obtained by recursive calculation of the centroids in the adaptive k-means clustering process.

In certain embodiments given by way of example, the operation 506, a cross-correlated time-frequency pseudo-distribution, can comprise the operation consisting of applying a cross-correlation with an increasing window width (period) and an increasing time offset to carry out a time-frequency decomposition on the real label sequence vector resulting from the operation 504. In certain embodiments given by way of example, the output of the operation 506 can comprise a real matrix with a time-frequency decomposition.

In certain embodiments given by way of example, the operation 508, a peak detection on a common energy, can comprise the operation consisting of calculating the common energy by summing all the windows for each time offset of the real matrix with a time-frequency decomposition resulting from the operation 506. The peak detection can be based on the detection of isolated and/or narrow peaks. The peaks detected can be correlated with the machine cycles and, thus, can indicate the machine cycles. In certain embodiments given by way of example, the output of the operation 508 can comprise a real common energy vector.

In certain embodiments given by way of example, the operation 508 can be preceded by one or more other operations, such as the operations consisting of storing items of information relating to the machine cycles detected (for example, in one or more data storage devices 212, 312, 412, 114, 120, 130, 134), retrieving the data, displaying the data, and/or moreover analyzing the data.

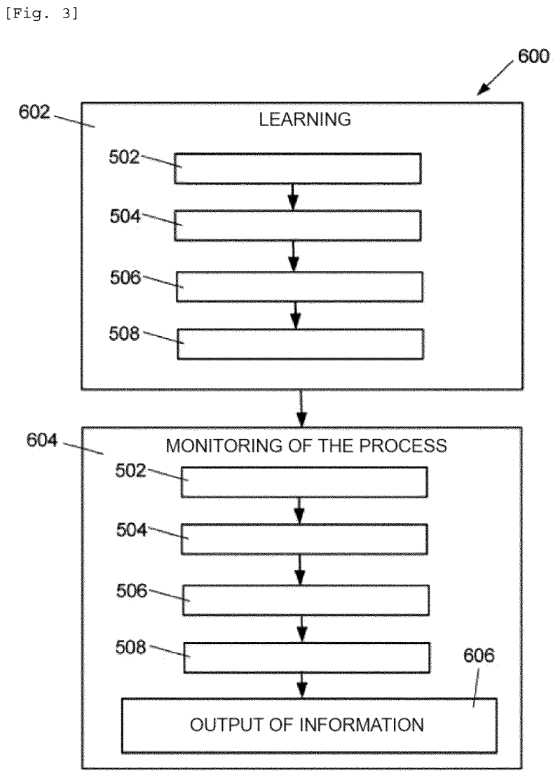

FIG. 3 is a schematic diagram of a machine monitoring method 600 given by way of example, as a function of at least certain aspects of the present disclosure. The operation 602 can comprise the learning operation, such as an unsupervised learning in which the system 100 analyses the data to automatically establish (or reestablish) base knowledge with regard to the operation of a particular machine. The operation 604 can follow the operation 602. The operation 604 can comprise the operation of monitoring the process, such as cycle counting, associated with the operation of the particular machine. In certain embodiments given by way of example, the system 100 can carry out the operation 602, the learning, after the initial installation of the system 100. Then, the system 100 can carry out the operation 604, the monitoring of the process, continuously. In certain embodiments given by way of example, the operation 602, the learning, can be repeated, for example on demand by a user, after a predetermined period of time, and/or if a significant change in the operational data is detected.

In certain embodiments given by way of example, the operation 602, the learning, can comprise the operations 502, 504, 506, and/or 508 described above with respect to FIG. 2. During the operation 502 in the operation 602, all the discrete Fourier transforms can be recorded. The data used, classified, and analyzed in the operation 602 can represent the primitive knowledge of the learning of the machine used in the operation 604. For example, in the operation 604, the input data are classified and analyzed with regard to the intended sequence defined in the operation 602.

In certain embodiments given by way of example, the operation 604, the monitoring of the process, can comprise the operations 502, 504, 506, and/or 508 described above with respect to FIG. 2. During the operation 502 in the operation 604, the discrete Fourier transforms may not be recorded and may be used only in real time for the operation 504. After the operation 504, the result of the operation 502 in the operation 604 can be abandoned (in order to avoid memory overflow). During the operation 504 in the operation 604, the number of groups can be fixed and the group centroids can move based on the recursive calculations. During the operation 506 in the operation 604, the analysis is concentrated on cycles identified previously. For example, on the operation 604, the operation 506 may not need to be carried out with a large range of offset time, but, rather, can be carried out only in a short range close to the intended cycle duration. During the operation 508 in the operation 604, in addition to the peak detection, other descriptors (for example the deviation, the skewness, the kurtosis) based on the common energy can be used to monitor the changes and the defects in the process. For example, any sudden or progressive change of the four first statistical moments can be analyzed as being a possible change or a fault in the process.

In certain embodiments given by way of example, the operation 604 can comprise an operation 606, which can comprise an operation consisting of outputting items of information, such as items of information relating to the operation of the machines 102, 104, 106, which can be displayed on the interface devices 122. In certain embodiments given by way of example, the operation consisting of outputting items of information 606 can comprise the operations consisting of identifying, detecting, determining, calculating, and/or transmitting items of information associated with one or more from among the following actions:
the production of a part by the machine
a total number of parts produced by the machine
a total cycle count of the machine
a log of the parts produced by the machine
a log of the machine cycles
a rate of production of parts by the machine
an efficiency of production
a cycle time needed for the production of a part or of a batch of parts
a deviation with respect to a predicted or historical parameter
a usage rate of the machine, such as the percentage of time during which the machine is used.

The operation 606 can comprise the operation consisting of preparing reports comprising data and/or items of information collected and/or processed. The operation 606 can comprise the operation consisting of generating automated alerts based on the comparison of the data and/or items of information with respect to predetermined threshold values and/or historical values. In certain embodiments given by way of example, the data and/or the items of information can be presented digitally and/or graphically on the interface devices 122.

In certain embodiments given by way of example, different operations 502, 504, 506, 508, 602, 604, 606 (or parts thereof) associated with the methods given by way of example 500, 600 can be carried out by any one or several of the processors 112, 118, 128, 132, 210, 310, 410 associated with different components of the system 100. In certain embodiments given by way of example, the methods 500, 600 can be substantially carried out by the processors 210, 310, 410 associated with the machine modules 200, 300, 400, respectively. The items of information given at output (operation 606) can be transmitted to the interface devices 122 directly and/or via the computing device 110 and/or the cloud-based computing device 116.

In certain embodiments given by way of example, at least certain operations 502, 504, 506, 508, 602, 604, 606 (or parts thereof) associated with the methods 500, 600 can be carried out by the processors 112, 118 associated with the computing device 110 and/or the cloud-based computing device 116, respectively. The machine modules 200, 300, 400 can be configured to transmit raw data and/or partially processed data to the computing device 110 and/or to the cloud-based computing device 116. The computing device 110 and/or the cloud-based computing device 116 can transmit outputted items of information (operation 606) to the interface devices 122.

In certain embodiments given by way of example, at least certain operations 502, 504, 506, 508, 602, 604, 606 (or parts thereof) associated with the methods 500, 600 can be carried out by the processors 128, 132 associated with the interface devices 122 (personal computer 124 and/or mobile device 126, respectively). The machine modules 200, 300, 400 can be configured to transmit raw data and/or partially processed data directly to the interface devices 122, which can carry out at least certain operations associated with the methods 500, 600. In certain embodiments given by way of example, the machine modules 200, 300, 400 can transmit raw data and/or partially processed data to the computing device 110 and/or to the cloud-based computing device 116 which can moreover transmit data to the interface devices 122. In certain embodiments given by way of example, the computing device 110 and/or the cloud-based computing device 116 can carry out at least certain operations associated with the methods 500, 600 before transmitting the data to the interface devices 122. In certain embodiments given by way of example, the interface devices 122 can produce at least some of the outputted items of information (operation 606) by processing the data received directly and/or indirectly from the machine modules 200, 300, 400.

In certain embodiments given by way of example, the data collected and/or processed by the system 100 can be used for purposes other than monitoring production. For example, certain systems 100 can be configured to identify and/or transmit alerts when certain conditions occur and/or are anticipated, such as a need for preventative maintenance and/or a breakdown of the machine.

In certain embodiments given by way of example, the system 100 can be able to operate with a minimum of user interaction required for the adjustments. For example, a machine module 200 can be installed on the machine 102, connected to the network 108, and powered. Then, the machine module 200 can automatically carry out the method 600, comprising the learning operation 602 and the operation of monitoring the process 604, substantially without further user interaction.

In different embodiments given by way of example as a function of at least certain aspects of the present disclosure, certain sensors given by way of example 202, 204, 206, 208, 302, 304, 402, 404, 406 can be configured to detect different parameters associated with the operation of the machines 102, 104, 106, such as one or more from among a vibration, a sound, a pressure, a movement, an acceleration, a temperature, a magnetic field, an electromagnetic field, and/or a light (optical).

Generally, the system 100 can comprise any sensor whatever able to detect physical measurement dynamics, such as accelerometers, microphones, extensometers, load sensors, piezoelectric patches or stacks, proximity sensors (with Faucault and/or capacitive currents), lasers, ultrasonic sensors, and/or cameras. In certain embodiments given by way of example, one or more sensors can be able to detect actions associated with a machine, such as the opening of a door, the changing of a tool, the loading or unloading of a part, etc. In certain embodiments given by way of example, the system 100 can be configured to distinguish between certain events (such as door opening, tool changing, etc.) with respect to normal operation of the machine and to filter these events during the analysis. In certain embodiments given by way of example, the system 100 can be configured to associate certain events (such as door opening, tool changing, etc.) with a machine operation and/or machine cycles and such events can be used during the analysis operations described in this application.

Annex 1 (attached to this application and incorporated into this disclosure) comprises additional items of information relating to the algorithms and mathematical operations given by way of example that can be used with respect to certain embodiments given by way of example as a function of at least certain aspects of the present disclosure. Annex 1 is provided for the purpose of explanation of certain embodiments given by way of example and must not be considered as being in any way limitative.

Although the present invention has been illustrated by a description of different embodiments, and although these embodiments have been described by means of significant details, it is not intended to restrict or limit in any way whatever the scope of the claims annexed to such details. The different characteristics shown and described in the present application can be used alone or in any combination whatever. Additional advantages and modifications will be easily apparent to a skilled person. More generally, the invention is therefore not limited to the specific details, to the representative device and method, or to the illustrative example represented and described.

1-17. (canceled)

18. An automated machine monitoring system, comprising:
a first sensor arranged to detect a first parameter associated with a first machine;
a first processor functionally coupled to receive data associated with the first parameter originating from the first sensor, the first processor being able to process the data associated with the first parameter by achieving at least one time-frequency decomposition, one phase clustering, one cross-correlated time-frequency pseudo-distribution, and one peak detection on a common energy to detect first machine cycles; and
an interface device able to display at least the data or items of information from among the processed data and the items of information relating to the data.

19. The system according to claim 18,
wherein the first processor is placed in a first machine module associated with the first machine; and
wherein the first machine module is functionally connected to the interface device by means of a network.

20. The system according to claim 18,
wherein the first sensor is functionally connected to a first machine module associated with the first machine; and
wherein the first processor is placed in a computing device, the computing device being functionally connected to the first machine module and to the interface device by means of a network.

21. The system according to claim 18,
wherein the first sensor is functionally connected to a first machine module associated with the first machine; and
wherein the first processor is placed in the interface device, the interface device being functionally connected to the first machine module by means of a network.

22. The system according to claim 18, wherein the first sensor is placed in a position from among on the first machine, in the first machine, and in a first machine module associated with the first machine.

23. The system according to claim 18, comprising moreover a second sensor arranged to detect a second parameter associated with the first machine, the second sensor being functionally connected to the first processor.

24. The system according to claim 18, wherein the first sensor is able to detect at least one from among a vibration, a sound, a pressure, a movement, an acceleration, a temperature, a magnetic field, an electromagnetic field, and a light.

25. The system according to claim 18, comprising moreover a second sensor arranged to detect a second parameter associated with a second machine; and a second processor functionally coupled to receive data associated with the second parameter originating from the second sensor, the second processor being able to process the data associated with the second parameter by at least one of the following actions consisting of carrying out a time-frequency decomposition, carrying out a phase clustering, carrying out a cross-correlated time-frequency pseudo-distribution, and carrying out a peak detection on a common energy to detect second machine cycles.

26. A method for data analysis by a first processor to identify and count machine cycles, the method comprising the operations consisting of: carrying out a time-frequency decomposition of a time signal associated with the operation of a machine in order to produce a complex matrix with a time-frequency decomposition;
carrying out a phase clustering on the complex matrix with a time-frequency decomposition in order to produce a real label sequence vector;
carrying out a cross-correlated time-frequency pseudo-distribution on the real label sequence vector in order to produce a real matrix with a time-frequency decomposition; and
carrying out a peak detection on a common energy on the real matrix with a time-frequency decomposition in order to produce a real common energy vector.

27. The method according to claim 26, comprising moreover, before the operation consisting of carrying out a time-frequency decomposition, the operation consisting of obtaining the time signal associated with the operation of the machine by collecting data via a sensor placed at least in one of the positions from among in and on the machine.

28. The method according to claim 26, wherein the operation consisting of carrying out a time-frequency decomposition comprises the operations consisting of applying a Hann window function and carrying out a short-time Fourier transform.

29. The method according to claim 26, wherein the operation consisting of carrying out a phase clustering comprises the operation consisting of carrying out an adaptive k-means clustering.

30. The method according to claim 26, wherein the operation consisting of carrying out a cross-correlated time-frequency pseudo-distribution comprises the operation consisting of applying a cross-correlation with an increasing window width and an increasing time offset.

31. The method according to claim 26, wherein the operation consisting of carrying out a peak detection on a common energy comprises the operation consisting of calculating a common energy by summing the windows for each time offset and detecting the peaks which are isolated and/or narrow.

32. The method for monitoring a machine, the method comprising a learning step implementing the operations of the method for data analysis according claim 26, and wherein the method comprises moreover a step of monitoring the process.

33. The method according to claim 32, wherein the step of monitoring the process comprises the operations consisting of carrying out a time-frequency decomposition of a time signal associated with the operation of a machine in order to produce a complex matrix with a time-frequency decomposition;
carrying out a phase clustering on the complex matrix with a time-frequency decomposition in order to produce a real label sequence vector;
carrying out a cross-correlated time-frequency pseudo-distribution on the real label sequence vector in order to produce a real matrix with a time-frequency decomposition;
carrying out a peak detection on a common energy on the real matrix with a time-frequency decomposition in order to produce a real common energy vector; and
outputting items of information relating to the operation of the machine.

34. The method according to claim 33, wherein the items of information relating to the operation of the machine comprises at least items of items of information from among the production of a part by the machine, a total number of parts produced by the machine, a total cycle count of the machine, a log of the parts produced by the machine, a log of the machine cycles, a rate of production of the parts by the machine, an efficiency of production, a cycle time required for the production of a part, a deviation with respect to a predicted parameter, and a usage rate of the machine.
